(19) United States
(12) Patent Application Publication
(10) Pub. No.: US 2026/0147311 A1
(43) Pub. Date: May 28, 2026

(54) IMAGE FORMING APPARATUS AND IMAGE FORMING SYSTEM

(71) Applicant: Takashi Ogiwara, Numazu Shizuoka (JP)

(72) Inventor: Takashi Ogiwara, Numazu Shizuoka (JP)

(73) Assignee: ETRIA CO., LTD., Kanagawa (JP)

(21) Appl. No.: 19/286,215

(22) Filed: Jul. 30, 2025

(30) Foreign Application Priority Data
Nov. 25, 2024 (JP) 2024-204623

(51) Int. Cl. G03G 21/20; G03G 15/00

(52) U.S. Cl. CPC G03G 21/206; G03G 15/5079; G03G 15/55; G03G 2221/1645

(57) ABSTRACT

According to an embodiment, an image forming apparatus includes a fan motor, a conveyance path, a pressure loss generating component, a current detector, and a processor. The fan motor is driven by electric power. The air flow generated by the fan motor passes through the conveyance path. The pressure loss generating component generates a pressure loss that changes the drive current value of the fan motor. The current detector measures the drive current value of the fan motor. The processor detects an abnormality in the pressure loss generating component when the drive current value of the fan motor detected by the current detector changes by an amount exceeding a predetermined threshold before a predetermined maintenance time comes.

### CROSS REFERENCE TO RELATED APPLICATIONS

This application is based upon and claims the benefit of priority from Japanese Patent Application No. 2024-204623,filed Nov. 25, 2024, the entire contents of which are incorporated herein by reference.

### FIELD

Embodiments described herein relate generally to image forming apparatuses and image forming systems.

### BACKGROUND

Image forming apparatuses placed in workplaces form a visible image corresponding to image data on the paper. Conventional image forming apparatuses include a mechanism that generates a flow of air by a fan motor and traps foreign matter by a filter provided in the air flow path. Conventionally, an electrophotographic image forming apparatus includes a mechanism that collects toner scattered outside a developing device, a mechanism that supplies outside air to a specific part, a mechanism that sucks air from the specific part, and the like.

Electrophotographic image forming apparatuses form a visible image (toner image) by attaching toner to an electrostatic latent image formed by light applied to a charged photoreceptor drum. Some electrophotographic image forming apparatuses include a toner suction unit for collecting toner scattered between the developing device and the photoreceptor drum. The toner suction unit is provided with a fan motor and a toner filter that traps toner contained in air sucked by the fan motor. In conventional image forming apparatuses, the toner filter is replaced at a time point set in advance according to, for example, the print volume.

However, when the toner suction unit sucks more toner than the expected amount, the toner filter may be clogged before the periodic maintenance. If the toner filter is clogged, it becomes difficult for the toner to be drawn into the toner suction unit, and the possibility of scattering the toner into the apparatus body increases. If the toner is scattered inside the apparatus body, not only cleaning takes time and effort but also it may cause components to malfunction. In order to solve such a problem, an image forming apparatus capable of detecting the state of a filter such as clogging is desired.

### BRIEF DESCRIPTION OF DRAWINGS

FIG. 1 is a schematic configuration diagram of a printing system including image forming apparatuses according to an embodiment.

FIG. 2 is a cross-sectional view schematically illustrating a configuration example of the image forming apparatuses according to the embodiment.

FIG. 3 is a block diagram illustrating a configuration example of the control system in each image forming apparatus according to the embodiment.

FIG. 4 is a cross-sectional view illustrating a configuration example of an electrophotographic image forming station in the image forming apparatus according to the embodiment.

FIG. 5 is an external view illustrating a configuration example of the toner suction unit in the image forming apparatus according to the embodiment.

FIG. 6 is a cross-sectional view illustrating a configuration example of the inside of the toner suction unit in the image forming apparatus according to the embodiment.

FIG. 7 is a diagram illustrating a configuration example of a path connecting the toner suction unit and the collection portion of the developing device in each image forming station in the image forming apparatus according to the embodiment.

FIG. 8 is a diagram illustrating a configuration example of a path connecting the toner suction unit and the collection portion of the developing device in each image forming station in the image forming apparatus according to the embodiment.

FIG. 9 is a diagram illustrating an example of a cause of an unexpectedly large amount of toner scattered from the developing device in the image forming apparatus according to the embodiment.

FIG. 10 is a diagram illustrating a correlation between the amount of toner trapped by the toner filter and the drive current value of the fan motor in the image forming apparatus according to the embodiment.

FIG. 11 is a flowchart for describing the state detection process in which the image forming apparatus according to the embodiment detects the state of the filter based on the drive current value of the fan motor.

FIG. 12 is a cross-sectional view illustrating a configuration example of a portion that supplies the air taken in from the outside of the apparatus body to the charging device in the ozone processing unit of the image forming apparatus according to the embodiment.

FIG. 13 is a view illustrating a state in which a cover is attached to the ozone processing unit shown in FIG. 12.

FIG. 14 is a cross-sectional view illustrating a configuration example of a portion that sucks air containing ozone from the charging device in the ozone processing unit of the image forming apparatus according to the embodiment.

FIG. 15 is a cross-sectional view illustrating a configuration example in which ozone contained in air sucked from the charging device is decomposed in the ozone processing unit shown in FIG. 14 and then exhausted.

### DETAILED DESCRIPTION

According to an embodiment, an image forming apparatus includes a fan motor, a conveyance path, a pressure loss generating component, a current detector, and a processor. The fan motor is driven by electric power. The air flow generated by the fan motor passes through the conveyance path. The pressure loss generating component generates a pressure loss that changes the drive current value of the fan motor. The current detector measures the drive current value of the fan motor. The processor detects an abnormality in the pressure loss generating component when the drive current value of the fan motor detected by the current detector changes by an amount exceeding a predetermined threshold before a predetermined maintenance time comes.

The image forming apparatus according to the embodiment will be described with reference to the drawings.

Note that, in each drawing used for the following description of the embodiment, the scale of each part is appropriately changed. In addition, in each drawing used for the following description of the embodiment, components are omitted as appropriate for the sake of explanation.

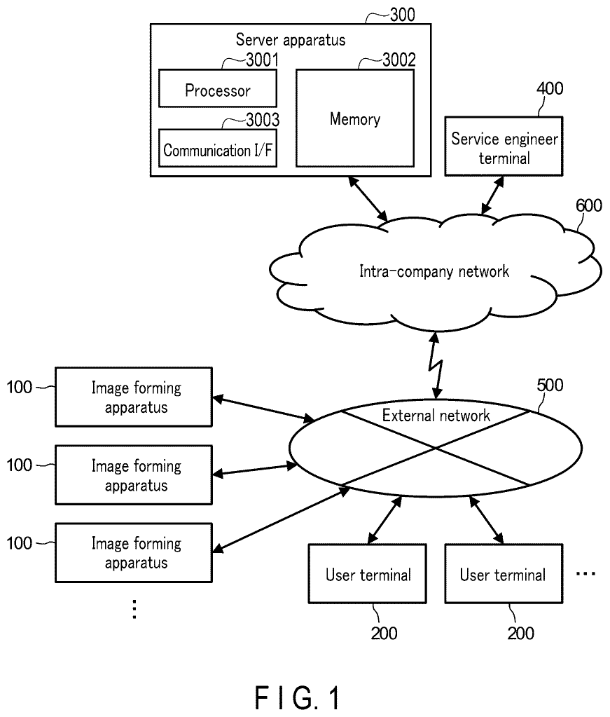

FIG. 1 is a schematic configuration diagram of a printing system (image forming system) including a plurality of image forming apparatuses 100 according to the embodiment. The printing system including the image forming apparatuses 100 further includes a plurality of user terminals 200, a server apparatus 300, and a service engineer terminal 400.

Each image forming apparatus 100 is placed in a work place and is communicably connected to, for example, a user terminal 200 placed in the same work place via an intra-company network 500 such as a local area network (LAN). This connection may be a wired connection or a wireless connection. The intra-company network 500 is connected to an external network 600 such as the Internet. The server apparatus 300 and the service engineer terminal 400 are connected to the external network 600. The image forming apparatuses 100 are communicably connected to the server apparatus 300 via the intra-company network 500 and the external network 600.

The user terminals 200 are information processing apparatuses that instruct printing in any of the image forming apparatuses 100. The user terminals 200 are, for example, information processing apparatuses such as personal computers (PC), smartphones, tablet terminals, or digital cameras. The user terminals 200 may be communicably connected to the image forming apparatuses 100 via the external network 600 and the intra-company network 500. That is, the user terminals 200 may be located outside the work places where the image forming apparatuses 100 are placed. The user terminals 200 may be directly connected to the image forming apparatuses 100 instead of being connected via the external network 600 and the intra-company network 500. That is, the user terminals 200 may be locally connected to the image forming apparatuses 100. When a user terminal 200 is locally connected to an image forming apparatus 100, the connection may be a wired connection or a wireless connection.

The server apparatus 300 is a computer apparatus operated directly by a management company that undertakes maintenance and inspection of the image forming apparatuses 100 or by outsourcing to a service provider. The server apparatus 300 acquires maintenance information of each image forming apparatus 100 periodically or as necessary. The maintenance information includes information indicating an operation status (number of prints, size and type of printed paper, etc.) of the image forming apparatus 100, information indicating the state of each unit (information indicating the state of a filter), etc. The server apparatus 300 may acquire notification data such as an alert transmitted from the image forming apparatuses 100.

The server apparatus 300 determines the necessity of inspection or repair (maintenance) of each image forming apparatus 100 based on the acquired data. When there is an image forming apparatus 100 that requires maintenance, the server apparatus 300 transmits information identifying the image forming apparatus 100 that requires maintenance to the service engineer terminal 400. As a result, a service engineer can be dispatched for the maintenance of the image forming apparatus 100 determined by the server apparatus 300 to require maintenance.

The server apparatus 300 is an information processing apparatus including a processor 3001, a memory 3002, a communication interface (I/F) 3003, and the like. The processor 3001 is, for example, a CPU. The processor 3001 executes various processes by executing programs stored in the memory 3002. The communication interface 3003 is an interface for communicating with each apparatus via the network 600. The memory 3002 includes storages such as a ROM, a RAM, and a non-volatile memory. The memory 3002 includes a program memory that stores a program, a working memory that temporarily holds data, and a data memory that accumulates data.

In the server apparatus 300, the memory 3002 has a storage area that stores a database that stores maintenance information and the like acquired from the image forming apparatuses 100. The processor 3001 of the server apparatus 300 stores information such as maintenance information acquired from the image forming apparatuses 100 in the database of the memory 3002. The processor 3001 of the server apparatus 300 determines the necessity of maintenance for each image forming apparatus based on the maintenance information of each image forming apparatus stored in the database.

The service engineer terminal 400 is an information processing apparatus such as a smartphone or a tablet terminal carried by a service engineer who performs maintenance of the image forming apparatuses 100. Although only one service engineer terminal 400 is illustrated in FIG. 1, the printing system may include a plurality of service engineer terminals 400. The service engineer terminal 400 may have a position detection function and transmit the position detected by the position detection function to the server apparatus 300 as the position information of the service engineer. The server apparatus 300 can also assign an appropriate service engineer to the image forming apparatus 100 that requires maintenance based on information such as the position information of each service engineer and the availability of each service engineer.

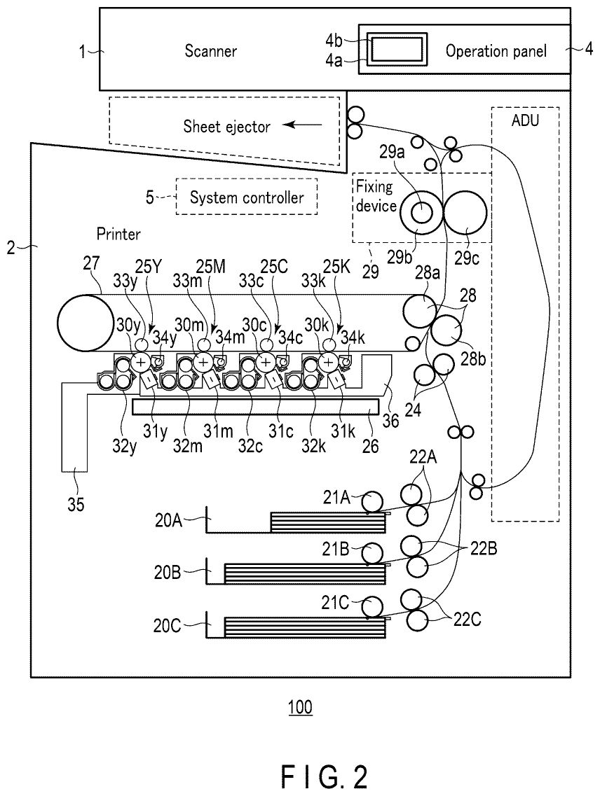

FIG. 2 is a cross-sectional view schematically illustrating a configuration example of the image forming apparatuses 100 according to the embodiment. The image forming apparatuses 100 according to the embodiment are assumed to be digital multi-functional peripherals (MFPs). In the configuration example illustrated in FIG. 2, the image forming apparatus 100 is a digital multi-functional peripheral including a scanner 1, a printer 2, an operation panel 4, and a system controller 5.

The scanner 1 is an apparatus that scans an image of a document and converts the image into image data. The scanner 1 includes, for example, a charge coupled device (CCD) line sensor that converts the image of the scanned side of the document into image data. The scanner 1 may have a function of scanning a document placed on a document glass. Further, the scanner 1 may have a function of scanning an image of a document conveyed by an auto document feeder (ADF). The scanner 1 is installed, for example, in an upper portion of the main body of the MFP as the image forming apparatus 100. The scanner 1 is controlled by the system controller 5. The scanner 1 outputs the image data of the document to the system controller 5.

The printer 2 forms an image on paper as a recording medium. The printer 2 is, for example, an electrophotographic printer. The image forming method of the image forming apparatuses 100 according to the present embodiment is not limited to the electrophotography. However, in the embodiment, the image forming apparatuses 100 will be described as including an electrophotographic printer 2. The printer 2 has a color printing function of printing a color image on paper and a monochrome printing function of printing a monochrome (e.g., black) image on paper. The printer 2 forms a color image using toners of a plurality of colors (e.g., three colors, namely, yellow (Y), cyan (C), and magenta (M)). The printer 2 forms a monochrome image using a monochrome (e.g., black (K)) toner.

In the configuration example illustrated in FIG. 2, the printer 2 includes a sheet feeding cassette 20(20A, 20B, 20C). The sheet feeding cassette 20 is a sheet feeder that supplies sheets on which images are to be printed. Further, the printer 2 may include a manual sheet feeding tray or the like as the sheet feeder. For example, each of the sheet feeding cassettes 20A, 20B, and 20C is detachably provided in the lower portion of the MFP's main body. Each of these sheet feeding cassettes 20A, 20B, and 20C contains a set type of sheet (e.g., size and paper type).

The sheet feeding cassettes 20A, 20B, and 20C include pickup rollers 21A, 21B, and 21C, respectively. Each of the pickup rollers 21A, 21B, and 21C extracts the sheets one by one from the corresponding sheet feeding cassette 20A, 20B, or 20C. Each of the pickup rollers 21A, 21B, and 21C supplies the extracted sheets to the conveyance path (conveyance portion 22) including a plurality of conveyance rollers 22A, 22B, and 22C.

The conveyance portion 22 conveys sheets in the printer 2. For example, the conveyance portion 22 conveys a sheet extracted by one of the pickup rollers 21A, 21B, and 21C to a registration roller 24. The registration roller 24 conveys the sheet to a transfer position when an image is transferred from a transfer belt 27 to the sheet. The conveyance portion 22 conveys the sheet having passed through the registration roller 24 to the transfer position. The conveyance portion 22 conveys the sheet having passed through the transfer position from the transfer position to a fixing device 29. The conveyance portion 22 conveys the sheet having passed through the fixing device 29 to either a sheet ejector or an automatic double-sided unit (ADU).

An image forming station 25 (25Y, 25M, 25C, 25K) forms the images to be transferred to the sheets. In the configuration example illustrated in FIG. 2, the image forming station 25Y forms images with the yellow toner. The image forming station 25M forms images with the magenta toner. The image forming station 25C forms images with the cyan toner. The image forming station 25K forms images with the black toner.

Each image forming station 25 (25Y, 25M, 25C, 25K) includes a photoreceptor drum 30 (30y, 30m, 30c, 30k), a charging device 31 (31y, 31m, 31c, 31k), a developing device 32 (32y, 32m, 32c, 32k), a transfer roller 33 (33y, 33m, 33c, 33k), and a cleaner 34 (34y, 34m, 34c, 34k).

The photoreceptor drums 30 are image carriers on which electrostatic latent images are formed. Each photoreceptor drum 30 is rotated by a rotation axis. Each charging device 31 charges the surface of the corresponding photoreceptor drum 30 to a predetermined potential. Each charging device 31 has a grid (not illustrated) for adjusting the charging output applied to the photoreceptor drum 30. Each developing device 32 develops the electrostatic latent image formed on the photoreceptor drum 30 with the toner. Each transfer roller 33 transfers the toner image developed on the photoreceptor drum 30 to the transfer belt 27. The cleaner 34 cleans the surface of the photoreceptor drum 30 after the transfer.

In addition, units such as a toner suction unit 35 and an ozone processing unit 36 are connected to each image forming station 25. The toner suction unit 35 collects toner scattered between the developing device 32 and the photoreceptor drum 30 in each image forming station 25. The ozone processing unit 36 sends outside air into the charging device 31 to suck gas containing ozone, and exhausts air after decomposing ozone from the sucked gas to the outside of the apparatus body.

Further, an exposure device 26 forms an electrostatic latent image on the photoreceptor drum 30 of each image forming station 25 (25Y, 25M, 25C, 25K) by laser light. The exposure device 26 irradiates the photoreceptor drum 30 with laser light controlled according to image data via an optical system such as a polygon mirror. The laser light from the exposure device 26 forms an electrostatic latent image on the surface of each photoreceptor drum 30. The exposure device 26 controls laser light in accordance with a control signal from the system controller 5.

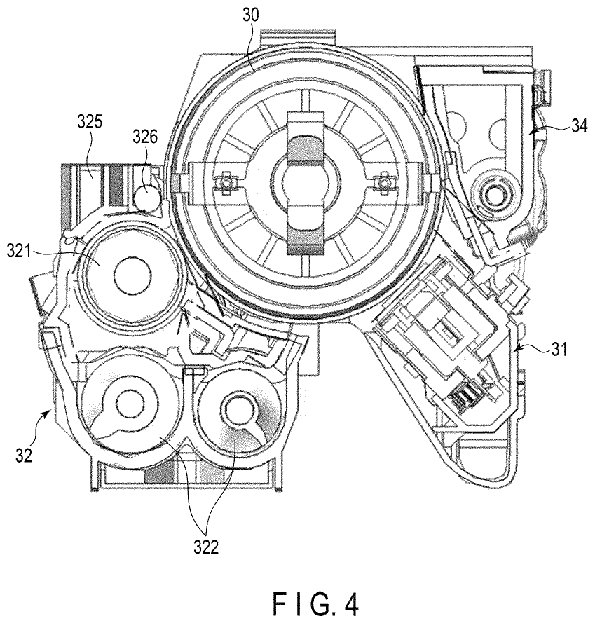

Each image forming station 25 (25Y, 25M, 25C, 25K) develops the electrostatic latent image formed on each photoreceptor drum 30 by each developing device 32. Each developing device 32 includes a developer container having a developing roller. The developer container stores a toner as a developer of the corresponding color. The toner is charged by being stirred in the developer container together with the carrier. A developing bias is applied to a developing roller 321 (see FIG. 4). When the developing bias is applied, the developing roller rotates with the toner adhered to its surface (peripheral surface), and supplies the toner on its peripheral surface to the electrostatic latent image on the photoreceptor drum 30. The electrostatic latent image on the photoreceptor drum 30 is developed as a toner image (visible image) by the supplied toner.

The developing device 32 is connected to the toner suction unit 35 for sucking toner scattered between the developing device and the photoreceptor drum 30. The developing device collects the toner scattered between the developing device 32 and the photoreceptor drum 30 and sends it out to the toner suction unit 35. The toner suction unit 35 sucks the scattered toner between the developing device 32 and the photoreceptor drum 30, and traps the sucked toner by a toner filter 353 described later.

The transfer belt 27 is an intermediate transfer member. Each image forming station 25 (25Y, 25M, 25C, 25K) transfers the toner image formed on the photoreceptor drum 30 onto the transfer belt 27 (primary transfer) by applying a primary transfer voltage to the transfer belt 27 by the transfer roller 33. For example, in the image forming station 25K, the transfer roller 33k transfers a toner image developed with a black toner by the developing device 32k onto the transfer belt 27. In the case of color image formation, each of the image forming stations 25Y, 25M, 25C, and 25K transfers the toner image developed with the toner of each color on the transfer belt 27 in an overlapping manner.

The transfer portion 28 transfers the toner image on the transfer belt 27 to the sheet at a secondary transfer position. The secondary transfer position is a position where the toner image on the transfer belt 27 is transferred onto the sheet. The secondary transfer position is a position where a support roller 28a and a secondary transfer roller 28b face each other.

The fixing device 29 fixes the toners to the sheet. The fixing device 29 applies heat to the sheet for fixing. In the example illustrated in FIG. 2, the fixing device 29 includes a heat roller 29b incorporating a heating portion 29a, and a pressure roller 29c pressed against a fixing belt heated by the heat roller 29b. The heating portion 29a may be any heater whose temperature can be controlled. For example, the heating portion 29a may be constituted by a heater lamp such as a halogen lamp, or may be an induction heating (IH) type heater. Further, the heating portion 29a may include a plurality of heaters. The fixing device 29 conveys the sheet subjected to the fixing treatment to either the sheet ejector or the ADU.

The operation panel 4 is a user interface. The operation panel 4 includes various buttons and a display portion 4a including a touch panel 4b. The system controller 5 controls the contents displayed on the display portion 4a of the operation panel 4. The display portion 4a displays a guide and the like. In addition, the operation panel 4 outputs information input to the touch panel 4b or a button of the display portion 4a to the system controller 5. The user designates an operation mode or inputs information such as setting information through the operation panel 4.

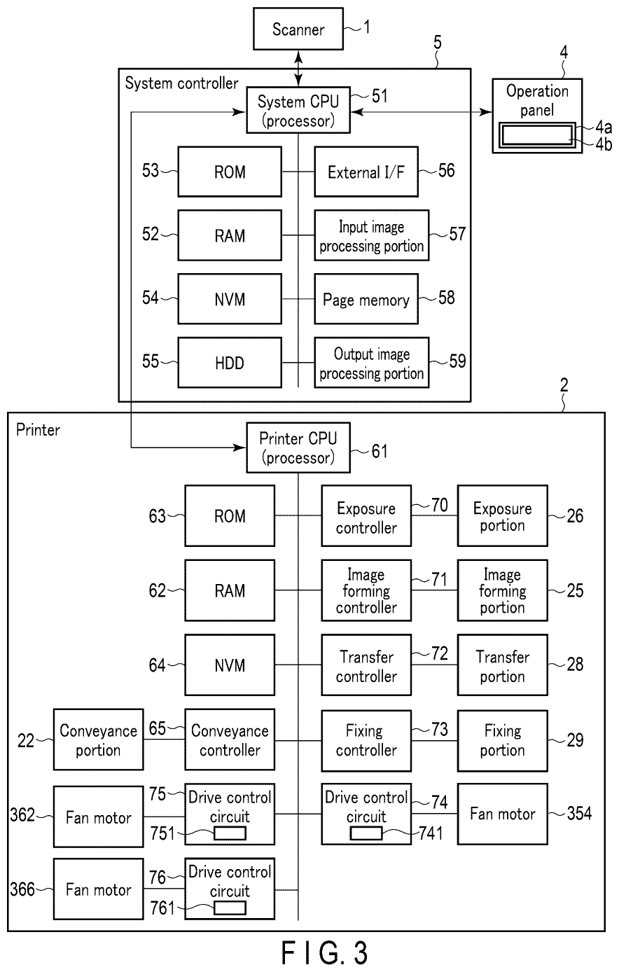

Next, a configuration of a control system in the image forming apparatuses 100 according to the embodiment will be described. FIG. 3 is a block diagram schematically illustrating a configuration example of the control system of the system controller 5 and the printer 2 in each image forming apparatus 100 according to the embodiment.

In the configuration example illustrated in FIG. 3, the system controller 5 includes a system central processing unit (CPU) 51 that is a processor, a random access memory (RAM) 52, a read only memory (ROM) 53, a non-volatile memory (denoted as NVM in FIG. 3) 54, a hard disk drive (HDD) 55, an external interface (denoted as I/F in FIG. 3) 56, an input image processing portion 57, a page memory 58, and an output image processing portion 59.

The system CPU (processor, first processor) 51 is a controller that centrally controls each unit of the image forming apparatus 100. The system CPU 51 is a processor that achieves processing by executing a program. The system CPU 51 is connected to each of the units in the system controller 5 via a system bus. The system CPU 51 is also connected to the scanner 1, the printer 2, the operation panel 4, and the like via the system bus. The system CPU 51 outputs operation instructions to and acquires various information from the scanner 1, the printer 2, and the operation panel 4 through bidirectional communication with them.

For example, when an image forming apparatus 100 is powered on, the system CPU 51 operates by executing a program stored in the ROM 53 (or the non-volatile memory 54). Further, the system CPU 51 instructs the printer 2 to perform printing indicated by a print job in response to reception of the print job from a user terminal 200. When copy is instructed on the touch panel 4b of the operation panel 4, the system CPU 51 performs copy control to cause the printer 2 to print an image of a document scanned by the scanner 1.

Note that the CPU, which is a processor included in the controller, may be a multi-core/multi-threaded processor, and can execute a plurality of processes in parallel. The processor is not limited to a CPU, and may be a micro processing unit (MPU). Further, the processor may be implemented in other various forms including an integrated circuit such as an application specific integrated circuit (ASIC), a graphics processing unit (GPU), a field-programmable gate array (FPGA), a digital signal processor (DSP), a system on a chip (SoC), or a programmable logic device (PLD). In addition, the processor may be a combination of a plurality of these.

The RAM 52 includes a volatile memory. The RAM 52 functions as a working memory or a buffer memory. The ROM 53 is a non-rewritable non-volatile memory that stores programs, control data, and the like. The system CPU 51 achieves various processes by executing programs stored in the ROM 53 (or the non-volatile memory 54 or HDD 55) while using the RAM 52. For example, the system CPU 51 achieves a function of instructing execution of printing and a function of prohibiting printing by executing programs.

The non-volatile memory 54 is a rewritable non-volatile memory. The non-volatile memory 54 stores a control program and control data executed by the system CPU 51. In addition, the non-volatile memory 54 stores various types of setting information, processing conditions, and the like. For example, the non-volatile memory 54 stores setting information for each sheet feeding cassette (sheet feeder).

The HDD 55 is a large-capacity storage. The HDD 55 stores image data, various types of operation history information, and the like. The HDD 55 may store a control program, control data, and the like. The HDD 55 may store setting information, processing conditions, and the like.

The external interface 56 is an interface for communicating with an external apparatus. For example, the external interface 56 receives a print job from a user terminal 200, which is an external apparatus, or transmits data to the server apparatus 300, which is also an external apparatus. The external interface 56 may be any interface that performs data communication with an external apparatus.

The input image processing portion 57 performs image processing on the image data scanned by the scanner 1. The input image processing portion 57 has functions such as shading correction processing, gradation conversion processing, inter-line correction processing, and compression/expansion processing, for example. The input image processing portion 57 stores the processed image data in the page memory 58.

The page memory 58 is used for expanding image data. For example, the page memory 58 stores image data obtained by causing the input image processing portion 57 to perform image processing on image data scanned by the scanner 1. The page memory 58 may store image data included in the print job acquired by the external interface 56.

The output image processing portion 59 generates print image data to be printed on paper by the printer 2. The output image processing portion 59 performs image processing for converting the image data stored in the page memory 58 into print image data. The output image processing portion 59 transmits the processed data to the printer 2.

Next, a configuration example of a control system in the printer 2 will be described.

In the configuration example illustrated in FIG. 3, the printer 2 includes, as control system components, a printer CPU 61, a RAM 62, a ROM 63, a non-volatile memory (NVM) 64, a conveyance controller 65, an exposure controller 70, an image formation controller 71, a transfer controller 72, a fixing controller 73, a drive control circuit 74, a drive control circuit 75, a drive control circuit 76, and the like.

The printer CPU 61 has control over the entire printer 2. The printer CPU 61 is a processor that achieves processing by executing a program. Note that the processor is not limited to a CPU, and may be implemented in other various forms including integrated circuits such as an MPU, an ASIC, a GPU, an FPGA, a DSP, an SoC, and a PLD. In addition, the processor may be a combination of a plurality of these.

The printer CPU 61 is connected to each unit in the printer 2 via a system bus or the like. The printer CPU 61 outputs operation instructions to each unit in the printer 2 in response to operation instructions from the system CPU 51. In addition, the printer CPU 61 notifies the system CPU 51 of information indicating the processing status of the printer 2.

The RAM 62 includes a volatile memory. The RAM 62 functions as a working memory or a buffer memory. The ROM 63 is a non-rewritable non-volatile memory that stores programs, control data, and the like. The printer CPU 61 achieves various processes by executing programs stored in the rom 63 (or the non-volatile memory 64) while using the RAM 62.

The non-volatile memory 64 is a rewritable non-volatile memory. For example, the non-volatile memory 64 stores a control program and control data executed by the printer CPU 61 and history data generated as a result of the printer CPU 61 executing the control program. In addition, the non-volatile memory 64 may store setting information, processing conditions, and the like.

The conveyance controller 65 controls conveyance of sheets in the printer 2. The conveyance controller 65 controls driving of the pickup rollers 21 and the conveyance rollers 22A, 22B, and 22C in the conveyance portion 22. The conveyance controller 65 controls driving of the conveyance rollers 22A, 22B, and 22C as the conveyance portion 22 in the printer 2 according to operation instructions from the printer CPU 61. For example, the printer CPU 61 instructs the conveyance controller 65 to perform sheet conveyance control in response to an instruction to start printing from the system controller 5.

The exposure controller 70 controls the exposure device 26. The exposure controller 70 forms an electrostatic latent image on the photoreceptor drum 30 (30y, 30m, 30c, 30k) of each image forming station 25 (25Y, 25M, 25C, 25K) by the exposure device 26 in response to an operation instruction from the printer CPU 61. For example, the exposure controller 70 controls the laser light with which the exposure device 26 irradiates each photoreceptor drum 30 according to image data which the printer CPU 61 has been instructed to print. For example, the exposure controller 70 controls scanning of the laser light emitted by each laser unit according to BD signals acquired from the exposure device 26.

The image forming controller 71 controls driving of each image forming station 25 (25Y, 25M, 25C, 25K). For example, the image forming controller 71 causes the charging device 31 to charge the photoreceptor drum 30 to a predetermined potential. The image forming controller 71 develops the electrostatic latent image formed on the photoreceptor drum 30 after the charging process with the toner image of each color by the developing device 32. The image forming controller 71 controls the density of the toner to be developed by controlling the developing bias or the like for the developing device 32. The image forming controller 71 transfers the toner image developed on the photoreceptor drum 30 to the transfer belt 27 by the transfer roller 33. In addition, the image forming controller 71 cleans the surface of the photoreceptor drum 30 after the transfer with the cleaner 34.

In addition, the transfer controller 72 controls driving of the transfer portion 28, a transfer current, and the like. In response to an operation instruction from the printer CPU 61, the transfer controller 72 causes the transfer portion 28 to transfer the toner image transferred onto the transfer belt 27 onto a sheet. The fixing controller 73 controls driving of the fixing device 29. The fixing controller 73 drives the heat roller 29b and the pressure roller 29c in response to an operation instruction from the printer CPU 61. The fixing controller 73 controls the heating portion 29a to control the surface temperature of the heat roller 29b to a fixing temperature.

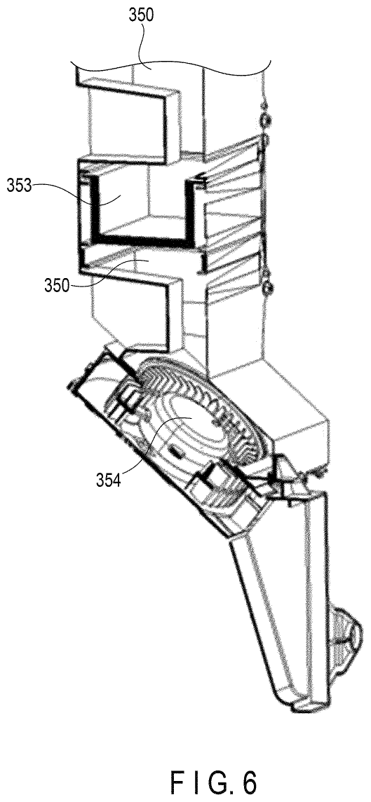

The drive control circuit 74 is used to drive a fan motor 354 (see FIG. 6) in the toner suction unit 35 provided with the toner filter (filter) 353. The drive control circuit 74 outputs drive power for rotating the fan of the fan motor 354 so as to obtain a predetermined flow rate. The drive control circuit 74 includes a current detector 741 that detects a drive current value flowing through the drive unit of the fan motor 354. The current value detected by the current detector 741 is supplied to the printer CPU 61 and the system CPU 51.

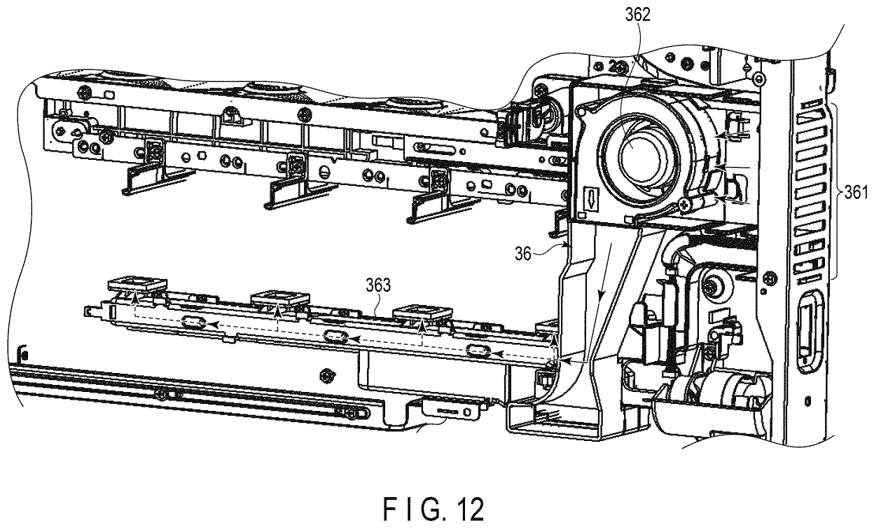

The drive control circuit 75 is connected to a fan motor 362 (see FIG. 12) for sucking outside air into the ozone processing unit 36 provided with a filter 361. The drive control circuit 75 outputs drive power for rotating the fan of the fan motor 362 so as to obtain a predetermined flow rate. The drive control circuit 75 includes a current detector 751 that detects a drive current value flowing through the drive unit of the fan motor 362. The current value detected by the current detector 751 is supplied to the printer CPU 61 and the system CPU 51.

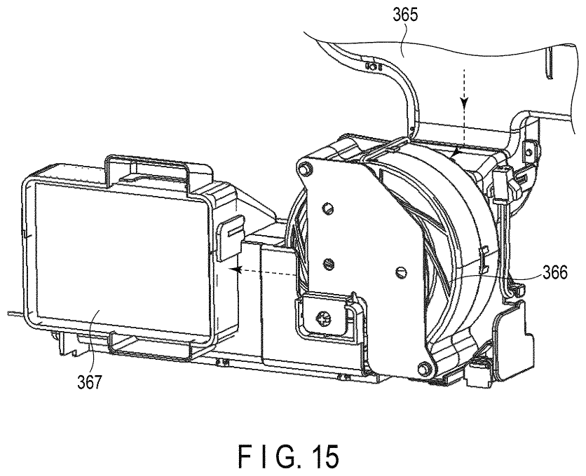

The drive control circuit 76 is connected to a fan motor 366 (see FIG. 15) for exhausting air from the ozone processing unit 36 provided with an ozone filter (filter) 367 to the outside of the apparatus body. The drive control circuit 76 outputs drive power for rotating the fan of the fan motor 366 so as to obtain a predetermined flow rate. The drive control circuit 76 includes a current detector 761 that detects a drive current value flowing through the drive unit of the fan motor 366. The current value detected by the current detector 761 is supplied to the printer CPU 61 and the system CPU 51.

In each image forming apparatus 100, the programs executed by the system CPU 51 or the printer CPU 61 can be stored in any writable storage. For example, programs may be written in a storage device in response to an operation by an administrator or the like. Further, programs or the like may be transferred by storing them in a removable computer-readable storage medium or through communication via a network. The form of the computer-readable storage medium is not limited as long as it is capable of storing programs and allows apparatuses to read the stored programs, and examples thereof include CD-ROM and memory cards.

Next, the configuration of the image forming station 25 (25Y, 25M, 25C, 25K) in the electrophotographic printer 2 of the image forming apparatus 100 will be described in detail.

FIG. 4 is a cross-sectional view illustrating a configuration example of the image forming station 25 (25Y, 25M, 25C, 25K) in the electrophotographic printer 2 of the image forming apparatus 100.

In each image forming station 25, as illustrated in FIG. 4, the charging device 31, the developing device 32, and the cleaner 34 are disposed on the surface of the photoreceptor drum 30 that rotates clockwise in the circumferential direction.

The charging device 31 includes a charging needle (charger) provided so as to face the surface of the photoreceptor drum 30. The charging device 31 generates corona discharge by the charging needle to charge the surface of the photoreceptor drum 30 to a predetermined potential. Since the charging needle generates corona discharge in the charging device 31, ozone is generated. The ozone generated in the charging device 31 is processed by the ozone processing unit 36 in order to prevent the photoreceptor drum 30 from being deteriorated by the ozone.

The ozone processing unit 36 decomposes ozone generated in the charging device 31 and discharges the ozone to the outside of the housing of the image forming apparatus 100 (apparatus body). The ozone processing unit 36 sends the air taken in from outside the apparatus body into the charging device 31, sucks air containing ozone in the charging device 31, decomposes the ozone from the sucked air, and exhausts the resulting air. In the charging device 31, when foreign matter such as dust accumulates, it interferes with the discharge from the charging needle. Therefore, the ozone processing unit 36 removes foreign matter such as dust from the air taken in from the outside of the apparatus body by the filter 361 (see FIG. 12), and sends the air that has passed through the filter 361 into the charging device 31.

After its surface is charged to a predetermined potential by the charging device 31, the photoreceptor drum 30 rotates to move a portion of its surface to an exposure position (between the charging device 31 and the developing device 32) for exposure to laser light from the exposure device 26. At the exposure position, the exposure device 26 irradiates the surface of the photoreceptor drum 30 charged to a predetermined potential with laser light controlled according to image data. By irradiating the surface of the photoreceptor drum 30 with the laser light from the exposure device 26, an electrostatic latent image corresponding to the image data is formed thereon.

A toner as a developer is supplied from the developing device 32 to the surface of the photoreceptor drum 30 on which the electrostatic latent image is formed by the exposure device 26. The electrostatic latent image formed on the surface of the photoreceptor drum 30 is developed as a toner image by the toner supplied from the developing device 32. That is, the developing device 32 supplies a developer (toner) to the electrostatic latent image formed on the surface of the photoreceptor drum 30 to create a visible image (toner image) by the toner.

As illustrated in FIG. 4, the developing device 32 includes a developing roller 321, a mixer 322, a collection portion 325, a collection roller 326, and the like. In the developing device 32, the mixer 322 stirs the toner and the carrier as the developer in the developer container. The mixer 322 supplies the toner mixed with the carrier to the surface of the developing roller 321. The developing roller 321 attracts the toner supplied from the mixer 322 to its surface by magnetic force. The developing roller 321 rotates with the toner attracted to (held on) its surface, thereby supplying the toner to the surface of the photoreceptor drum 30 located near the developing roller 321 at a predetermined developing position. As a result, the electrostatic latent image formed on the photoreceptor drum 30 is developed with the toner supplied from the developing roller 321.

The toner image as a visible image developed on the surface of the photoreceptor drum 30 is transferred to the transfer belt 27 by the transfer roller 33 between the developing device 32 and the cleaner 34. Further, the toner image transferred to the transfer belt 27 is transferred to a sheet. The cleaner 34 is configured to clean the surface of the photoreceptor drum 30 after the toner image is transferred to the transfer belt 27.

In the configuration example illustrated in FIG. 4, the developing roller 321 draws air into the developing device 32 when it rotates in a predetermined direction. When the developing roller 321 rotates, the internal pressure of the developing device 32 increases. The developing device 32 is tightly sealed in order to prevent toner leakage, and any gaps generated at mating portions of components are filled with a sealant. However, since the developing device 32 delivers the toner to the surface of the photoreceptor drum 30 at the developing position, a gap (air outlet) is formed between the developing device 32 and the photoreceptor drum 30.

The air outlet is formed in the upper area of a part through which the surface of the developing roller 321 passes after the toner is supplied to the photoreceptor drum 30 (the upper area of a part where the developing roller 321 and the photoreceptor drum 30 face each other). In the developing device 32, the part of toner that left the developing roller 321, and the part of toner stirred up into the air by the carrier are attracted toward the air outlet and scattered to the outside of the developing device 32. The scattering of the toner to the outside of the developing device 32 tends to increase as the rotation speed of the developing roller 321 increases.

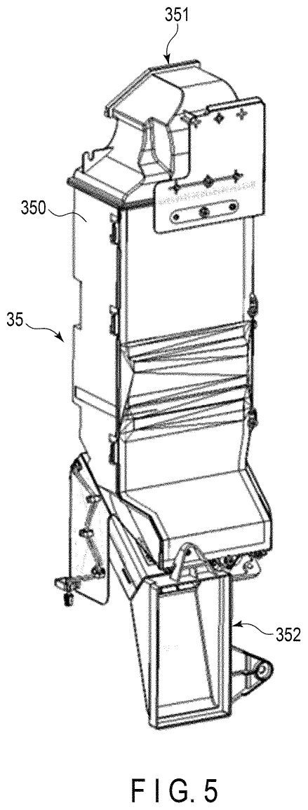

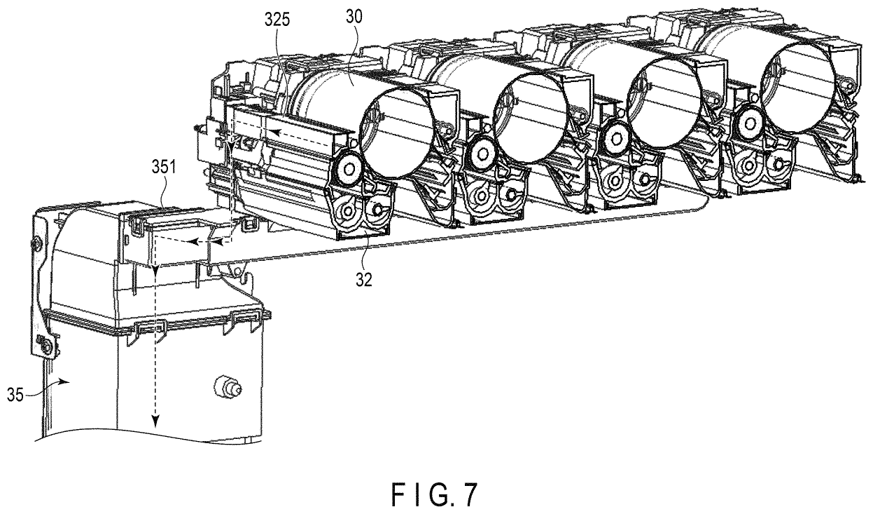

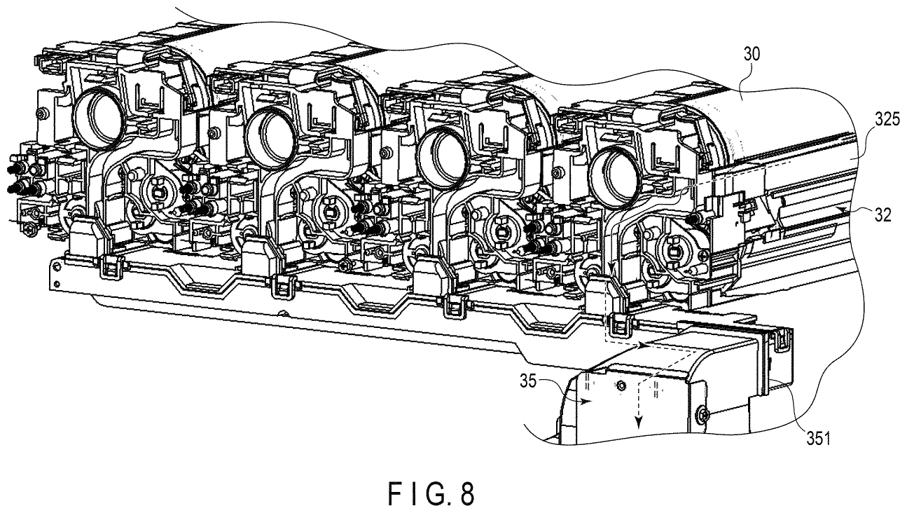

The developing device 32 includes a scattered toner collection portion 325 for collecting toner scattered from the air outlet. The collection roller 326 is provided in the scattered toner collection portion 325. The collection roller 326 attracts the toner to its charged surface. The collection portion 325 collects the toner by scraping the toner on the collection roller 326 with a blade. The collection portion 325 is connected to the toner suction unit 35 illustrated in FIGS. 5 and 6 through a path such as the one illustrated in FIGS. 7 and 8 to be described later. The collection portion 325 sends the toner collected using the collection roller 326 to the toner suction unit 35 together with air via the path illustrated in FIGS. 7 and 8.

Next, the toner suction unit 35 in the image forming apparatus 100 according to the embodiment will be described.

FIG. 5 is an external view illustrating a configuration example of the toner suction unit 35 in the image forming apparatus 100 according to the embodiment. FIG. 6 is a cross-sectional view illustrating an example of the configuration inside the toner suction unit 35. FIGS. 7 and 8 are diagrams illustrating a configuration example of a path connecting the toner suction unit 35 and the collection portion 325 of the developing device 32 in the image forming station 25.

As illustrated in FIG. 5, the toner suction unit 35 forms a duct (conveyance path) 350 and includes an internal connection unit 351 and an external connection unit 352. As illustrated in FIG. 6, the toner suction unit 35 includes the toner filter (pressure loss generating component) 353 and fan motor 354 in the duct 350. The toner filter 353 is installed in the middle of the duct 350 serving as an air (gas) flow path. The fan motor 354 is provided in the vicinity of the external connection unit 352 in the duct 350.

In the fan motor 354, the fan rotates so as to discharge the air in the duct 350 serving as the toner suction unit 35 from the external connection portion 352. The fan motor 354 sucks air from the internal connection portion 351 into the duct 350, and discharges the air that has passed through the toner filter 353 in the duct 350 from the external connection portion 352.

The toner filter 353 traps toner contained in the air passing through the duct 350 of the toner suction unit 35. As illustrated in FIG. 6, the toner filter 353 is installed in the form of a bag with respect to the flow path of the air in the duct 350, and stores the trapped toner. The toner filter 353 is installed so as to be replaceable during maintenance.

As illustrated in FIGS. 7 and 8, in the toner suction unit 35, the internal connection portion 351 is connected to the collection portion 325 of the developing device 32 in each image forming station 25. The air in the collection portion 325 of each image forming station 25 is sucked by the toner suction unit 35. In FIGS. 7 and 8, the flow path of air from the collection portion 325 of the developing device 32 to the toner suction unit 35 is indicated by solid and dotted arrows.

As illustrated in FIG. 7, the collection portion 325 of the developing device 32 conveys air containing toner scattered between the developing roller 321 and the photoreceptor drum 30 to the back side of the image forming apparatus 100 (the connection portion of the toner suction unit 35). As illustrated in FIG. 8, the airflows conveyed to the back side by the collection portions 325 merge into a duct connected to the internal connection portion 351 of the toner suction unit 35 to be sent into the toner suction unit 35.

In the toner suction unit 35 illustrated in FIG. 6, the greater the amount of toner trapped (toner accumulated on the toner filter) by the toner filter 353 as the pressure loss generating component, the greater the effect of obstructing the passage of air. When the toner trapped by the toner filter 353 interferes with the passage of air, it becomes difficult for the toner suction unit 35 to draw in air containing toner from the collection portion 325. If the state in which it is difficult for the air in the collection portion 325 to flow to the toner suction unit 35 continues for a long period of time, the toner is likely to scatter into the apparatus body other than the developing device 32.

The image forming apparatus 100 is designed such that the flow of air from the collection portion 325 to the toner suction unit 35 remains normal until the amount of toner trapped by the toner filter 353 reaches a predetermined allowable amount. Therefore, in the image forming apparatus 100, the periodic maintenance is carried out so that the toner filter 353 is replaced before the trapped toner amount of the toner filter 353 reaches the predetermined allowable amount.

For example, in the image forming apparatus 100, normal maintenance (periodic maintenance) is set according to the total number of printed pages (total number of printed pages) or the conveyance distance (drive counter) of the printer 2. In the image forming apparatus 100, various filters including the toner filter 353 can be replaced in normal maintenance by a service engineer or the like. The image forming apparatus 100 is designed so that the toner filter 353 can maintain its normal function until periodic maintenance on the assumption that the amount of scattered toner from the developing device 32 is within an expected range (normal range). That is, if the actual amount of scattered toner is within the expected range, the toner suction unit 35 can normally collect the scattered toner by replacing the toner filter 353 in the periodic maintenance.

However, the actual amount of scattered toner from the developing device 32 may increase due to various causes. It is difficult to identify in advance the cause of toner scattering in an amount exceeding the expected range. Therefore, if the amount of scattered toner exceeds the expected range significantly, it is necessary to prompt maintenance without waiting for the periodic maintenance in order to suppress the occurrence of malfunction in the apparatus body.

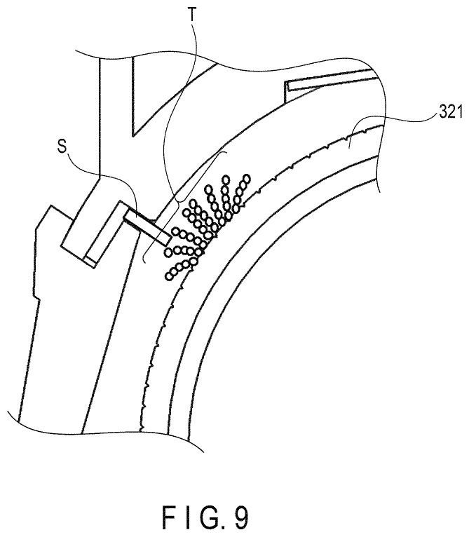

FIG. 9 is a diagram illustrating an example of a cause of toner scattering from the developing device 32 in an amount exceeding the expected amount.

In the developing device 32, the developing roller 321 attracts the toner T to its surface (peripheral surface) by magnetic force. The developing roller 321 conveys the toner T to the photoreceptor drum 30 by rotating with the toner T adhered to its peripheral surface. As illustrated in FIG. 9, the toner T on the rotating developing roller 321 is held so as to expand radially outward at the magnetic pole position.

On the other hand, a developer container formed by combining a plurality of components is provided around the developing roller 321 so that toner or the like is not released to the outside of the developing device 32. The components forming the developer container of the developing device 32 are joined with a sealant so that no gaps are formed. FIG. 9 illustrates an example in which a sealant S located at a joining portion of components in the developing device 32 protrudes toward the developing roller 321. Normally, the sealant S does not protrude in the developing device 32, and the protrusion of the sealant S as illustrated in FIG. 9 occurs, for example, due to a defect in the manufacturing process.

As illustrated in FIG. 9, at the portion where the sealant S protrudes, part of the toner T on the peripheral surface of the rotating developing roller 321 comes into contact with the sealant S. The part of the toner T that comes into contact with the sealant S is physically stripped from the developing roller 321. As a result, in the developing device 32 illustrated in FIG. 9, due to the protrusion of the sealant S, a greater amount of toner T than is expected is stripped from the developing roller 321.

In the developing device 32, as described above, airflow is generated by the rotation of the developing roller 321 toward the air outlet (the gap between the developing device 32 and the photoreceptor drum 30) at which the collection portion 325 is provided. Therefore, the airflow in the developing device 32 guides most of the toner T stripped from the developing roller 321 into the collecting portion 325 serving as the air outlet. As a result, as illustrated in FIG. 9, in a developing device 32 in which the sealant S protrudes, the amount of toner scattered into the collection portion 325 is significantly larger than that in a normal developing device 32.

If the amount of scattered toner increases due to an unexpected cause as illustrated in FIG. 9, the amount of toner trapped by the toner filter 353 exceeds the expected range. In normal maintenance (periodic maintenance), the toner filter 353 is replaced on the assumption that toner scattered from the developing device 32 in its normal condition is collected. If the amount of scattered toner exceeds the expected range due to an unexpected cause, the amount of toner trapped by the toner filter 353 before performing normal maintenance exceeds the predetermined allowable amount (toner full). When the toner filter 353 is toner full, the toner filter 353 is less likely to allow air to pass therethrough. When the toner filter 353 is less likely to allow air to pass therethrough, it becomes difficult for the toner suction unit 35 to draw in toner from the collection portion 325 of each developing device 32.

The image forming apparatus 100 according to the embodiment detects information indicating the state of a filter such as the toner filter 323 separately from normal maintenance (periodic maintenance). The image forming apparatus 100 determines whether or not the information indicating the state of the filter (the drive current value of the fan motor) is a value indicating abnormality. If the information indicating the state of the filter is a value indicating abnormality, the image forming apparatus 100 stores the information indicating that the state of the filter is abnormal as maintenance information to be notified to the server apparatus 300. As a result, the image forming apparatus 100 can communicate the information indicating the abnormal state of the filter separately from normal maintenance, and prompt maintenance according to the abnormal state of the filter.

Next, a state detection process of detecting the state of a filter in the image forming apparatus 100 according to the embodiment will be described.

The image forming apparatus 100 according to the embodiment detects the state of a filter (pressure loss generating component) based on a drive current value of a fan motor that generates airflow through the filter. The image forming apparatus 100 stores, in the NVM 64, information indicating a correlation between the filter state and the drive current value of the fan motor that generates airflow through the filter. The image forming apparatus 100 detects (estimates) the state of the filter from the drive current value of the fan motor based on the correlation. The image forming apparatus 100 notifies the server apparatus 300 of information indicating the state of the filter. As a result, the server apparatus 300 can guide maintenance including filter replacement according to the state of the filter in the image forming apparatus.

In the following, a state detection process for detecting when the amount of toner trapped by the toner filter 353 is equal to or greater than the limit allowable amount (allowable limit) as the filter state will be described.

In the toner suction unit 35, the amount of toner trapped by the toner filter 353 (amount of toner trapped) and the drive current value of the fan motor 354 are correlated. When the amount of toner trapped by the toner filter 353 increases, the drive current value of the fan motor 354 driven by the drive control circuit 74 decreases. This is considered to be because the obstruction of air passing through depends on the amount of toner trapped by the toner filter 353.

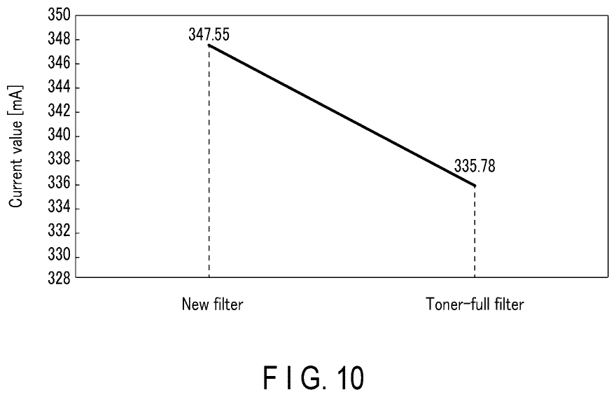

FIG. 10 is a diagram illustrating a relationship between the amount of toner trapped by the toner filter 353 and the drive current value of the fan motor 354.

As illustrated in FIG. 10, the drive current value of the fan motor 354 is at its maximum when the toner filter 353 has no toner trapped thereon (new filter). When printing is executed, the toner suction unit 35 sucks the toner scattered from the developing device 32, and thus the trapped toner accumulates on the toner filter 353.

As the toner accumulated on the toner filter 353 increases, the drive current value of the fan motor 354 gradually decreases until the amount of toner trapped by the toner filter 353 reaches its allowable limit (toner full). According to the correlation as illustrated in FIG. 10, the image forming apparatus 100 can estimate (detect) the amount of toner trapped by the toner filter 353 from the drive current value of the fan motor 354. In addition, if the threshold value is set according to the drive current value of the fan motor 354 in the toner-full state, the image forming apparatus 100 can detect (estimate) that toner full has been reached based on the detected actual drive current value of the fan motor 354.

Next, the flow of the state detection process in which the image forming apparatus 100 according to the embodiment detects the state of the filter based on the drive current value of the fan motor will be described.

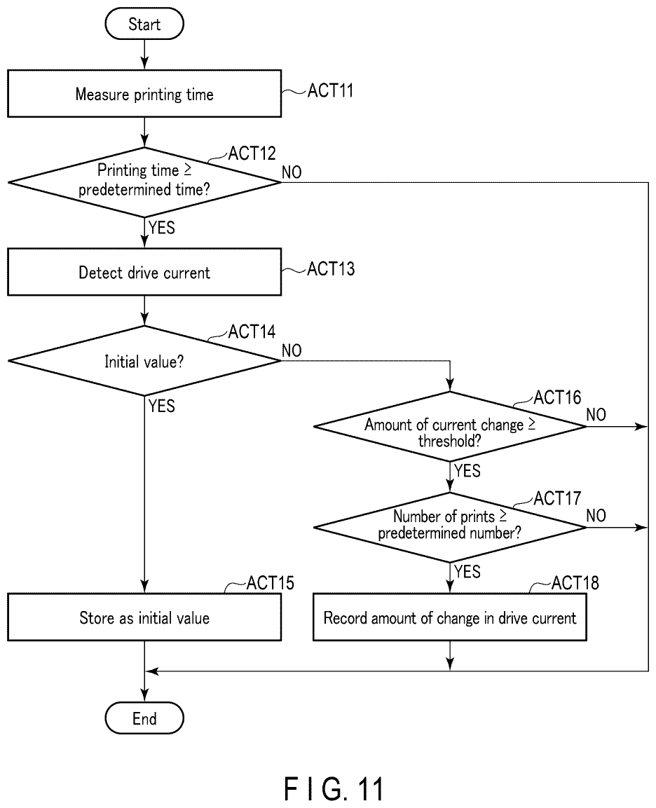

FIG. 11 is a flowchart for describing the state detection process in which the image forming apparatus 100 according to the embodiment detects the state of the filter based on the drive current value of the fan motor.

Here, a process is described in which, as the filter state, it is detected that the amount of toner trapped by the toner filter 353 has reached the allowable limit during printing based on the drive current value of the fan motor 354.

First, the system CPU 51 of the image forming apparatus 100 executes printing by the printer 2. When executing printing, the system CPU 51 measures an elapsed time from the start of printing (ACT 11). As the state detection process, the system CPU 51 monitors whether or not the elapsed time from the start of printing has elapsed a predetermined time (start time of the state detection process) (ACT 12).

The start time of the state detection process is a time for stabilizing the drive current value of the fan motor 354 in the toner suction unit 35. The drive current value of the fan motor 354 is unstable immediately after the start of printing. In order to stabilize the drive current value of the fan motor 354 as information indicating the state of the toner filter 353, the state detection process is not performed until the predetermined time elapses. The system CPU 51 of the image forming apparatus 100 executes the state detection process for detecting the state of the filter after the predetermined time (e.g., 30 seconds) has elapsed from immediately after the start of printing.

When the elapsed time from the start of printing has passed the predetermined time (ACT 12, YES), the system CPU 51 detects the drive current value of the fan motor 354 in the toner suction unit 35 (ACT 13). After the predetermined time has elapsed, the system CPU 51 acquires the current value (drive current value) flowing through the drive unit of the fan motor 354 detected by the current detector 741 of the drive control circuit 74. For example, the system CPU 51 continuously acquires a plurality of current values detected by the current detector 741 during a predetermined measurement period (e.g., 5 seconds), and acquires their mean as a drive current value (AVE) of the fan motor 354.

After acquiring the drive current value (AVE) of the fan motor 354, the system CPU 51 determines whether or not to set the acquired current value as an initial value (INI) of the drive current value of the fan motor 354 (ACT 14). If the system CPU 51 determines to set the detected drive current value as the initial value (ACT 14, YES), it stores the drive current value in the NVM 54 as the initial value of the drive current value of the fan motor 354 (ACT 15).

For example, the system CPU 51 stores, in the NVM54, a drive current value (AVE) of the fan motor 354 detected first after installing a new toner filter 353 as the initial value (INI). In addition, the system CPU 51 may store the drive current value (AVE) acquired by executing the process of ACT 11 to 13, a setup process executed immediately after replacing the toner filter 353, in the NVM54 as the initial value (INI).

If the detected drive current value (AVE) is not the initial value (ACT 14, NO), the system CPU 51 determines whether the amount of change in current based on the detected drive current value (AVE) and the initial value (INI) is equal to or greater than a predetermined threshold (MAX) (ACT 16). The predetermined threshold (MAX) is a set value for determining whether or not the toner filter 353 has reached its allowable limit (toner full) based on the amount of change in the drive current value (INI−AVE). For example, the predetermined threshold is set based on the difference between the drive current value in the case of a new filter illustrated in FIG. 10 and the drive current value in the case of a toner-full filter.

As the determination made in ACT 16, the system CPU 51 may determine whether or not a value ((INI−AVE)/(MAX)) obtained by dividing the difference (INI-AVE) between the initial value of the drive current value and the detected drive current value by the predetermined threshold (MAX) exceeds “1”. In this case, if (INI−AVE)/(MAX)>1, the system CPU 51 determines that the toner filter 353 is at the allowable limit.

If the amount of change in the drive current value is less than the predetermined threshold (ACT 16, NO), the system CPU 51 determines that the amount of toner trapped by the toner filter 353 is not at the allowable limit. If the state of the toner filter 353 is not the allowable limit, the system CPU 51 ends the state detection process for the toner filter 353.

Note that the system CPU 51 may estimate the state of the toner filter 353 (e.g., the amount of toner trapped) from the drive current value (or amount of current change) of the fan motor 354 based on the correlation between the amount of toner trapped and the drive current value as illustrated in FIG. 10. In that case, the system CPU 51 may store information indicating the state of the toner filter 353 estimated from the drive current value of the fan motor 354 in the NVM54 as maintenance information of the image forming apparatus 100. The system CPU 51 may also transmit the information indicating the state of the toner filter 353 as the maintenance information to the server apparatus 300.

If the amount of current change is equal to or greater than the predetermined threshold (ACT 16, YES), the system CPU 51 determines that the amount of toner trapped by the toner filter 353 has reached the allowable limit. If it is determined that the toner filter 353 has reached the allowable limit, the system CPU 51 determines whether the total number of prints (the total number of times printing has been executed) is equal to or greater than a determination criterion (predetermined number) for determining abnormality of the amount of toner scattered (ACT 17).

The image forming apparatus 100 determines that the amount of toner scattered is abnormal if the amount of toner scattered from the developing device 32 during printing exceeds the normal range. That is, the image forming apparatus 100 determines that the amount of toner scattered is abnormally large (the amount of toner scattered is abnormal) if the toner filter 353 reaches the allowable limit when the total number of prints is obviously small. Conversely, the image forming apparatus 100 does not determine that the amount of toner scattered is abnormal when the total number of prints corresponds to the periodic maintenance even if the toner filter 353 is determined to be at the allowable limit.

The system CPU 51 of the image forming apparatus 100 determines whether or not the amount of toner scattered from the developing device 32 during printing exceeds the normal range based on a predetermined number as a determination criterion with respect to the total number of prints. The determination criterion for determining whether or not the amount of toner scattered is abnormal may be a criterion for determining whether or not the amount of toner scattered is in its normal range. For example, the predetermined number as the criterion for determining whether the amount of toner scattered is abnormal may not be the total number of prints set as a trigger condition for periodic maintenance. The predetermined number as the determination criterion may be set to a value smaller than the total number of prints set as a trigger condition for periodic maintenance.

If the system CPU 51 determines that the toner filter 353 has reached its allowable limit and the total number of prints is less than the predetermined number (ACT 17, YES), information indicating the state of the toner filter 353 is stored in a memory such as the NVM 54 (ACT 18). The information indicating the state of the toner filter 353 may be the amount of change in the drive current value of the fan motor 354, flag information indicating the allowable limit (toner full) of the toner filter, or the like.

In addition, the system CPU 51 stores information indicating the state of the toner filter in a predetermined storage area of the NVM 54 as part of information (maintenance information) indicating the state of the image forming apparatus 100. The system CPU 51 transmits the maintenance information including the information indicating the state of the toner filter 353 stored in the predetermined storage area of the NVM 54 to the server apparatus 300.

The system CPU 51 may transmit the maintenance information including the information indicating the state of the toner filter 353 to the server apparatus 300 at predetermined transmission intervals (periodically). The system CPU 51 may transmit the maintenance information including the information indicating the state of the toner filter 353 to the server apparatus 300 if the information indicating the state of the toner filter 353 is stored in the predetermined storage area (i.e., YES in ACT 17).

The server apparatus 300 acquires the maintenance information from the image forming apparatus 100 through the communication interface 3003. The processor (second processor) 3001 of the server apparatus 300 stores the maintenance information acquired from the image forming apparatus 100 in a database provided in the memory 3002. The processor 3001 determines the necessity of maintenance from the maintenance information stored in the database. For example, when the total number of prints reaches the trigger condition for periodic maintenance, the processor 3001 transmits, to the service engineer terminal 400, a guide that prompts periodic maintenance of the image forming apparatus 100.

If the processor 3001 of the server apparatus 300 receives the maintenance information including the information indicating the state of the filter, it transmits, to the service engineer terminal 400, a guide for prompting maintenance of the image forming apparatus 100 according to the state of the filter. For example, if the processor 3001 receives information indicating that amount of toner trapped is abnormal, it transmits a guide for notifying the abnormality in the amount of toner trapped to the service engineer terminal 400. Further, if the processor 3001 receives information indicating that the amount of toner trapped is abnormal, it may also transmit, to the service engineer terminal 400, a guide for prompting confirmation such as repair or replacement of the part (e.g., the developing device) that caused the scattering of a large amount of toner.

As described above, the image forming apparatus according to the embodiment can detect that the amount of toner trapped by the toner filter is abnormally large from the drive current value of the fan motor. In addition, since the image forming apparatus can detect that the amount of toner trapped is abnormally large, it can detect that scattering of the toner from the developing device is abnormal, and prompt replacement of the developing device considered to have some kind of defect.

In general, in image forming apparatuses, the phenomenon in which a toner is scattered in the apparatus body is more likely to occur if a toner filter that has trapped the allowable limit (toner full) amount of toner is left as is. The image forming apparatus according to the embodiment transmits the state of the toner filter to the server apparatus when the toner filter is detected to be toner full before the normal maintenance time comes. Therefore, the server apparatus can notify the service engineer of the state of the toner filter in the image forming apparatus. As a result, the image forming apparatus can prevent a defect caused by the toner scattered in the apparatus body in advance, and can suppress time and cost required for maintenance such as cleaning of the apparatus body and part replacement.

### MODIFIED EXAMPLE

Next, an example of a filter other than the toner filter 353 applicable as a modified example of the above-described embodiment will be described.

The above-described state detection process for detecting the state of the filter can be performed by a similar procedure for filters other than toner filters. That is, the above-described embodiment is not limited to detecting the state of toner filters. The image forming apparatus 100 includes a fan motor that supplies air (gas) taken in from the outside of the apparatus body to a specific portion in the apparatus body, a fan motor that exhausts gas in a specific portion to the outside of the apparatus body, or the like.

Next, the ozone processing unit 36 will be described as a component including a filter other than the toner filter included in the image forming apparatus 100.

As described above, the ozone processing unit 36 is configured to process ozone generated by the charging device 31. The ozone processing unit 36 roughly includes a portion that supplies air taken in from the outside of the apparatus body to the charging device 31 and a portion that sucks air containing ozone from the charging device 31.

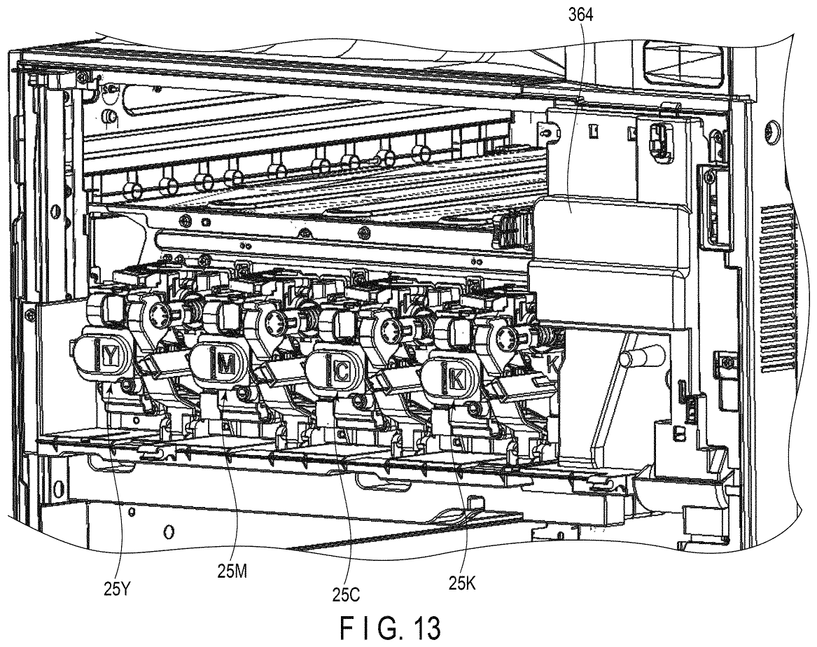

FIG. 12 is a cross-sectional view illustrating a configuration example of a portion that supplies the air taken in from the outside of the apparatus body to the charging device 31 in the ozone processing unit 36. FIG. 13 is a view illustrating a state in which a cover is attached to the ozone processing unit 36 shown in FIG. 12.

As illustrated in FIG. 12, the ozone processing unit 36 includes the filter 361, the fan motor 362, the duct 363, and the like as components for supplying outside air to the charging device 31. The filter 361 removes foreign matter such as dust contained in the air taken in from the outside of the apparatus body. The fan motor 362 takes in air outside the apparatus body and generates an airflow for supplying the air to the charging device 31 of each imaging station 25. The duct 363 forms flow paths of air from the filter 361 to each charging device 31. The duct 363 includes a flow path of air taken into the fan motor 362 from the outside of the apparatus body via the filter 361, and a flow path of air supplied from the fan motor 362 to each charging device 31.

The filter 361 is provided in a slit provided in the housing (apparatus body) of the image forming apparatus 100. The filter 361 removes foreign matter such as dust contained in the air taken into the apparatus body through the slit from the outside of the apparatus body. Foreign matter such as removed dust may adhere to the filter 361 and accumulate thereon.

The fan motor 362 rotates the fan so as to take in air outside the apparatus body from the slit provided with the filter 361. The fan motor 362 rotates the fan using power supplied from the drive control circuit 75. Similarly to the drive control circuit 74, the drive control circuit 75 supplies a drive voltage to the drive unit of the fan motor 362 so that the flow rate of the fan motor 362 becomes a predetermined flow rate. The drive control circuit 75 also includes the current detector 751 that detects the current value (drive current value) flowing through the drive unit of the fan motor 362.

As illustrated in FIG. 13, an inner cover 364 is attached to the duct 363 in the image forming apparatus 100. In the duct 363, the fan motor 362 causes air to flow as indicated by solid or dotted arrows in FIG. 12. The duct 363 has outlets for supplying air to the charging devices 31 of the image forming stations 25. As illustrated in FIG. 13, the outlets of the duct 363 are each connected to a charging device 31 of the corresponding image forming station 25 (25Y, 25M, 25C, 25K). As a result, the air taken in by the fan motor 362 from the outside of the apparatus body via the filter 361 is supplied to the charging device 31 of each image forming station through the duct 363.

The filter (dust filter) 361 as illustrated in FIG. 12 may be an example of the pressure loss generating component because a pressure loss may be generated by a substance attached thereto, such as dust. It is considered that the drive current value of the fan motor 362 fluctuates when a pressure loss occurs in the filter 361. The amount of substances attached to the filter 361 and the drive current value of the fan motor 362 are considered to have a correlation similar to that illustrated in FIG. 10. If such a correlation exists, the drive current value of the fan motor 362 indicates the state of the filter 353 similarly to the drive current value of the fan motor 354 with respect to the filter 353. That is, also for the filter 361, a state detection process based on the drive current value of the fan motor 362 can be performed, similarly to the process described with reference to FIG. 11.

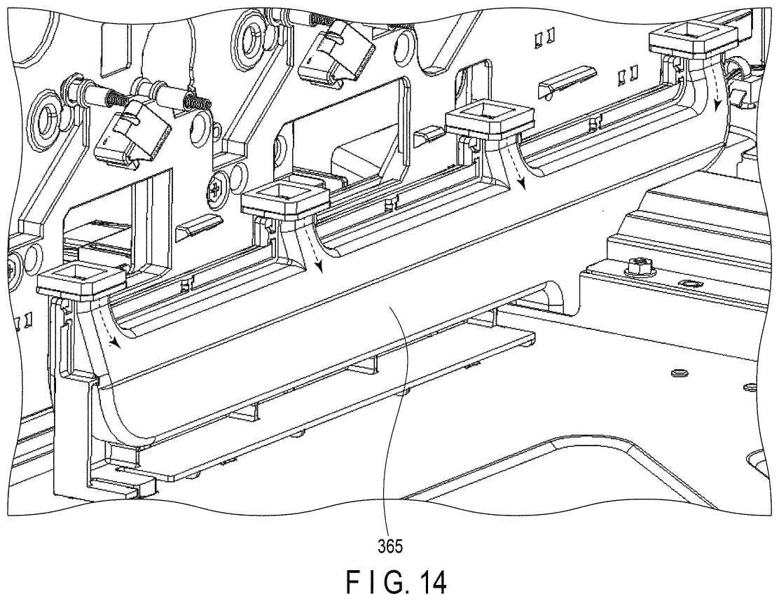

FIG. 14 is a cross-sectional view illustrating a configuration example of a portion (ozone suction side) that sucks air containing ozone from the charging device 31 in the ozone processing unit 36. FIG. 15 is a cross-sectional view illustrating a configuration example in which ozone contained in air sucked from the charging device 31 is decomposed in the ozone processing unit 36 shown in FIG. 14 and then exhausted.

Note that FIGS. 14 and 15 are cross-sectional views of the inside of the body of the image forming apparatus 100 as viewed from the back side. FIGS. 12 and 13 are cross-sectional views of the inside of the body of the image forming apparatus 100 as viewed from the front side (operation panel side). The structure on the ozone suction side shown in FIGS. 14 and 15 is arranged on the back side (back surface) with respect to the structure on the air delivery side shown in FIGS. 12 and 13.

The ozone processing unit 36 includes the duct 365, the fan motor 366, and the ozone filter 367 as components for decomposing and discharging ozone contained in the air from the charging device 31. In the charging device 31, ozone is generated by corona discharge. The ozone generated in the charging device 31 is discharged to the duct 365 together with the air supplied from the duct 364 described above.

The duct 365 is connected to the casing of the charging device 31 on a side opposite to the duct 363, through which air is supplied to the charging device 31.

In the duct 365, the fan motor 366 causes air to flow as indicated by solid or dotted arrows in FIGS. 14 and 15. As illustrated in FIG. 14, the duct 365 has a suction port for sucking air containing ozone from the charging device 31 of each image forming station 25 (25Y, 25M, 25C, 25K). The duct 365 forms a flow path through which air sucked from each charging device 31 flows. In the duct 365, as illustrated in FIG. 15, the air sucked from each charging device 31 flows to the fan motor 366 through the duct 365.

The fan motor 366 rotates the fan so as to send the air containing ozone sucked from each charging device 31 to the ozone filter 367. The fan motor 366 rotates the fan using drive power supplied from the drive control circuit 76. Similarly to the drive control circuit 74, the drive control circuit 76 supplies a drive voltage to the drive unit of the fan motor 366 so that the flow rate of the fan motor 366 becomes a predetermined flow rate. The drive control circuit 76 also includes the current detector 761 that detects the current value (drive current value) flowing through the drive unit of the fan motor 366.

The filter (ozone filter) 367 decomposes ozone contained in the air. The ozone filter 367 is provided most downstream of the air flow path in the duct 365. The ozone filter 367 decomposes ozone contained in the air supplied by the fan motor 366, and releases (exhausts) the air obtained by decomposing the ozone to the apparatus body side.

The ozone filter 367 as shown in FIGS. 14 and 15 can also be an example of the pressure loss generating component if there is a possibility that pressure loss occurs due to, for example, substances attached thereto. It is considered that the drive current value of the fan motor 366 fluctuates when a pressure loss occurs due to the ozone filter 367. It is considered that there is a certain correlation between the change in state of the filter 367 and the drive current value of the fan motor 362. If such a correlation exists, the drive current value of the fan motor 366 changes depending on the state of the filter 357, similarly to the drive current value of the fan motor 354 with respect to the filter 353. Therefore, also for the filter 357, a state detection process based on the drive current value of the fan motor 366 can be performed, similarly to the process described with reference to FIG. 11.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus comprising:
a fan motor driven by electric power;
a conveyance path through which air caused to flow by the fan motor moves;
a pressure loss generating component that generates a pressure loss that changes a drive current value of the fan motor;
a current detector that measures the drive current value of the fan motor; and
a processor that detects an abnormality in the pressure loss generating component if an amount of change in the drive current value of the fan motor detected by the current detector exceeds a predetermined threshold before a predetermined maintenance time arrives.

2. The image forming apparatus according to claim 1, further comprising
a memory that stores an initial value of the drive current value of the fan motor detected by the current detector,
wherein the processor detects an abnormality in the pressure loss generating component if the amount of change in the drive current value between the drive current value of the fan motor detected by the current detector and the initial value exceeds the predetermined threshold.

3. The image forming apparatus according to claim 1,
wherein the processor detects the drive current value of the fan motor by the current detector after a predetermined time has elapsed from the start of image formation.

4. The image forming apparatus according to claim 1, further comprising
an image forming station that forms an image using a toner,
wherein the pressure loss generating component is a toner filter that traps the toner scattered from the image forming station.

5. The image forming apparatus according to claim 4,
wherein the processor detects that an amount of toner trapped by the toner filter has reached an allowable limit if the amount of change in the drive current value of the fan motor detected by the current detector exceeds the predetermined threshold.

6. The image forming apparatus according to claim 4,
wherein the processor detects that an amount of toner scattered is abnormal if the amount of change in the drive current value of the fan motor detected by the current detector exceeds the predetermined threshold and the number of times of image formation has reached a predetermined number.

7. The image forming apparatus according to claim 6,
wherein the predetermined threshold is set based on a correlation between an amount of toner trapped by the toner filter and the drive current value of the fan motor.

8. The image forming apparatus according to claim 1,
wherein the pressure loss generating component is a filter that traps foreign matter in air taken into the image forming apparatus from outside the image forming apparatus by the fan motor.

9. The image forming apparatus according to claim 1,
wherein the pressure loss generating component is a filter that decomposes a specific substance contained in air to be exhausted from the inside of the image forming apparatus to the outside of the image forming apparatus by the fan motor.

10. The image forming apparatus according to claim 1, further comprising
an external interface that communicates with a server apparatus,
wherein, if the processor detects an abnormality in the pressure loss generating component, the processor transmits information indicating the abnormality in the pressure loss generating component to the server apparatus through the external interface.

11. An image forming system comprising an image forming apparatus and a server apparatus,
wherein the image forming apparatus includes:
an external interface that communicates with the server apparatus;
a fan motor driven by electric power;
a conveyance path through which air caused to flow by the fan motor moves;
a pressure loss generating component that generates a pressure loss that changes a drive current value of the fan motor;
a current detector that measures the drive current value of the fan motor; and
a first processor that transmits information indicating an abnormality in the pressure loss generating component to the server apparatus if an amount of change in the drive current value of the fan motor detected by the current detector exceeds a predetermined threshold before a predetermined maintenance time arrives, and
the server apparatus includes:
a communication interface that communicates with the image forming apparatus and a service engineer terminal; and
a second processor that transmits a guide for prompting maintenance of the image forming apparatus to the service engineer terminal if the information indicating an abnormality in the pressure loss generating component is acquired from the image forming apparatus through the communication interface.

12. The image forming system according to claim 11, further comprising
a memory that stores an initial value of the drive current value of the fan motor detected by the current detector,
wherein the processor detects an abnormality in the pressure loss generating component if the amount of change in the drive current value between the drive current value of the fan motor detected by the current detector and the initial value exceeds the predetermined threshold.

13. The image forming system according to claim 11,
wherein the processor detects the drive current value of the fan motor by the current detector after a predetermined time has elapsed from the start of image formation.

14. The image forming system according to claim 11, further comprising
an image forming station that forms an image using a toner,
wherein the pressure loss generating component is a toner filter that traps the toner scattered from the image forming station.

15. The image forming system according to claim 14,
wherein the processor detects that an amount of toner trapped by the toner filter has reached an allowable limit if the amount of change in the drive current value of the fan motor detected by the current detector exceeds the predetermined threshold.

16. The image forming system according to claim 14,
wherein the processor detects that an amount of toner scattered is abnormal if the amount of change in the drive current value of the fan motor detected by the current detector exceeds the predetermined threshold and the number of times of image formation has reached a predetermined number.

17. The image forming system according to claim 16,
wherein the predetermined threshold is set based on a correlation between an amount of toner trapped by the toner filter and the drive current value of the fan motor.

18. The image forming system according to claim 11,
wherein the pressure loss generating component is a filter that traps foreign matter in air taken into the image forming apparatus from outside the image forming apparatus by the fan motor.

19. The image forming system according to claim 11,
wherein the pressure loss generating component is a filter that decomposes a specific substance contained in air to be exhausted from the inside of the image forming apparatus to the outside of the image forming apparatus by the fan motor.

20. The image forming system according to claim 11, further comprising
an external interface that communicates with a server apparatus,
wherein, if the processor detects an abnormality in the pressure loss generating component, the processor transmits information indicating the abnormality in the pressure loss generating component to the server apparatus through the external interface.
